(19) United States
(12) Patent Application Publication
(10) Pub. No.: US 2014/0115948 A1
(43) Pub. Date: May 1, 2014

(54) FISHING LURE OSCILLATION ATTACHMENT

(71) Applicant: James Fred Matson, Pottstown, PA (US)

(72) Inventor: James Fred Matson, Pottstown, PA (US)

(21) Appl. No.: 14/064,230

(22) Filed: Oct. 28, 2013

Related U.S. Application Data
(60) Provisional application No. 61/720,598, filed on Oct. 31, 2012.

(51) Int. Cl. A01K 85/14

(52) U.S. Cl. CPC A01K 85/14
USPC 43/42.25; 43/42.53

(57) ABSTRACT

A fishing rig for use in catching fish includes a fly or a lure attached to a hook having an eye, a quadratic surface having first and second ports disposed centrally on the quadratic surface and extending through the surface, and a leader of filament passing first through the first port of the quadratic surface, through the eye of the fly or lure, then through the second port forming a loop upon which the quadratic surface is free to slide to and away from the eye.

### CROSS REFERENCE TO RELATED APPLICATIONS

This application claims priority to U.S. provisional patent application No. 61/720,598, filed on Oct. 31, 2012 entitled FISHING LURE OSCILLATION ATTACHMENT, and incorporates all of the same by reference as if set forth herein in its entirety.

### STATEMENT AS TO FEDERALLY SPONSORED RESEARCH

Not applicable.

### BACKGROUND OF INVENTION

a. Field of Invention

The invention relates generally to the field of fishing lures. More particularly, the invention refers to a device for use in modifying the action of fly or a lure, a fishing rig, a method of rigging a fly or lure, and a method of making oscillation attachments that create the illusion of life of the fly or lure when the rig is pulled through the water.

b. Background of Invention

Flies and lures are frequently used in recreational and sport fishing to catch fish. Generally, a fly or other fishing lure such as a rubber bait is attached to a fishing line and is designed to resemble bait, using motion, color and/or vibration, to attract the fish, causing it to bite the lure, and an attached hook. Many fishing flies and lures may include a single j-hook forming part of, or embedded within the fly or lure. These types of flies or lures are often lacking and do not do not provide sufficient life-like movement of the lure when in use.

In fishing, it is always desirable to provide features which either give a more life like appearance to the fly or lure, and are more attractive to the fish (resulting in a higher hit frequency). The present invention is aimed at the problem identified above.

### SUMMARY OF INVENTION

In one aspect of the present invention, a fishing rig for use in catching fish is provided. The fishing rig includes a fly or a lure attached to a hook having an eye, and a quadratic surface having first and second ports disposed centrally on the quadratic surface A leader of filament is passed first through the first port of the quadratic surface, through the eye of the fly or lure, then through the second port forming a loop upon which the quadratic surface is free to operate in a rocking fashion relative to the eye.

In another aspect of the present invention, a fishing rig for use in catching fish is provided. The fishing rig includes a quadratic surface formed by providing a forming plate having a semi-cylindrical shaped trough, placing a disc of material over the semi-cylindrical shaped trough, providing a cylindrical or semi-cylindrical shaped forming bar, heating the disc, and pressing the disc into the semi-cylindrical shaped trough with the forming bar. A forming mat is used to isolate the disc(s) from the forming plate.

In another embodiment of the present invention, a method of rigging a fly or lure for use in fishing is provided. The method comprises providing a fly or a lure having a hook forming part of, or embedded within the fly or lure, the hook having an eye. Also provided is a quadratic surface on a circular domain (shaped from a circular disc). The quadratic surface has first and second ports disposed centrally on the quadratic surface that extend through the surface. A length of leader is provided. The length of a leader extends from a first end to a second end or portion. The first end of the leader is passed through the quadratic surface at the first port, then through the eye of the hook, then through the second port. The first end of the leader is then connected with the second end of the leader.

Additional features, advantages, and embodiments of the invention may be set forth or apparent from consideration of the following detailed description. Moreover, it is to be understood that both the foregoing summary of the invention and the following detailed description are exemplary and intended to provide further explanation without limiting the scope of the invention.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a top perspective of a quadratic surface of the fishing rig;

FIG. 2 is a bottom perspective view of the quadratic surface of the fishing rig;

FIG. 3 is a side perspective view of the quadratic surface of the fishing rig; and

FIG. 4 is a bottom plan view of the quadratic surface of the fishing rig;

FIG. 5 is a top plan view of the quadratic surface of the fishing rig;

FIG. 6 is a front elevation view of the quadratic surface of the fishing rig;

FIG. 7 is a side elevation view of the quadratic surface of the fishing rig;

FIG. 8 is a view in perspective of the fishing rig of the fishing rig;

FIG. 9 is a view in perspective of the fishing rig of the fishing rig;

FIG. 10 is a view in perspective of the fishing rig of the fishing rig;

FIG. 11 is a view in perspective of a forming plate according to an embodiment of the present invention.

FIG. 12 is a view in perspective of a forming plate and forming mat according to an embodiment of the present invention.

FIG. 13 is a view in perspective of a forming plate and forming mat with discs placed on the forming mat according to an embodiment of the present invention.

FIG. 14 is a view in perspective of a forming bars pressing the discs and the forming mat into the forming plate according to an embodiment of the present invention.

### DETAILED DESCRIPTION OF THE EMBODIMENTS

Embodiments of the present invention include a fishing rig for use in catching fish, a quadratic surface for use in connection with a fishing rig, and a method of rigging a fly or lure. Although particular embodiments of the invention are described in detail herein with reference to the accompanying drawings, it is to be understood that the invention is not limited to those particular embodiments, and that various changes and modifications, including the omission of steps or the interchangeability of the order of steps, may be effected therein by one skilled in the art without departing from the scope or spirit of the invention.

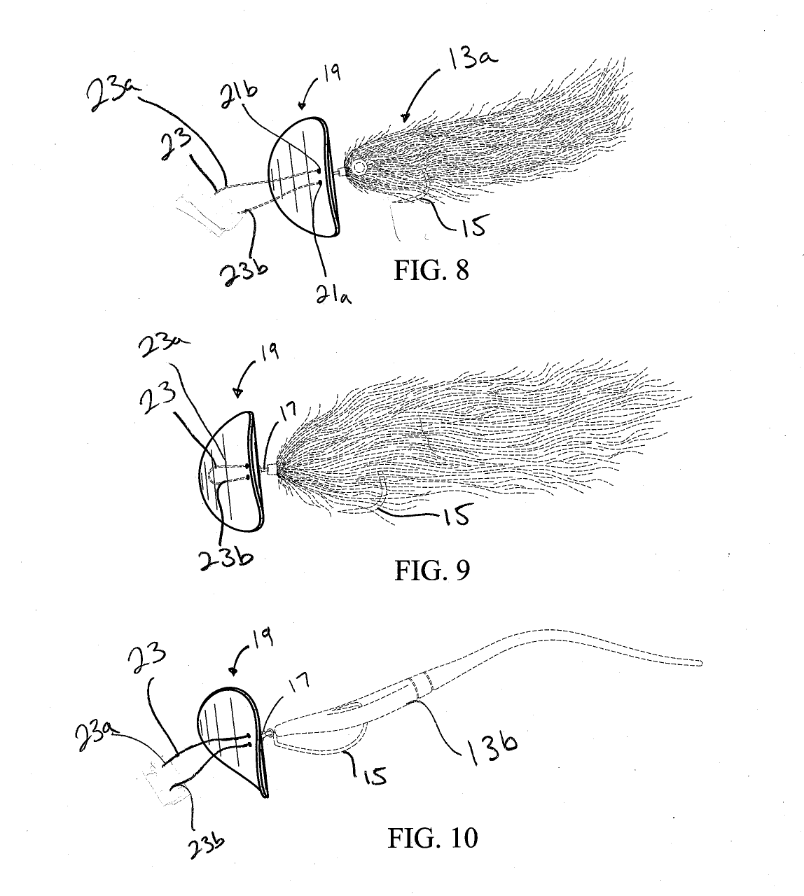

Referring to the Figures in general, and in particular to FIGS. 8-10, there is shown a fishing rig 11 for use in fishing. The fishing rig 11 is suitable for use in freshwater or saltwater fishing environments and may be used to attract fish of any type, size, and within any environment. The fishing rig 11 comprises a fly or lure 13 having a hook 15 forming part of, or embedded within, the fly or lure 13. The hook 15 also has an eye 17 that is used to connect the hook 15 with other elements of fishing apparatus.

The rig 11 includes a quadratic surface 19 having first and second ports (21a, 21b) disposed centrally on the quadratic surface 19 and extending through the surface 19. The rig 11 further includes a leader 23 passing first through the first port 21a of the quadratic surface 19, through the eye 17 of the fly or lure, then through the second port 21b forming a loop 27. The loop 27 connects the quadratic surface 19 to the eye 17 of the hook 15 freely to enable the quadratic surface 19 to move (or rock from side to side) relative to the eye 17 of the hook 15. When not under any forces, the loop 27 enables the quadratic surface 19 freedom to slide to and away from the eye 17. The purpose of the loop 27 is to provide freedom of the surface 19 to rock from side to side relative to the eye 17 of the hook 15. The leader 23 may be adapted to be coupled to a fishing rod (not shown) to enable a user to cast the fishing rig 11 into a location to enable the fishing rig 11 to attract the fish to the fishing rig 11 when the rig 11 is retrieved.

In a preferred embodiment, the surface 19 is oriented on the rig 11 such the trough 29 of the surface 19 is oriented generally parallel to a plane occupied by the hook 15. In other words, when the eye 17 of the hook 15 occupies a plane roughly perpendicular (or twisted 90 degrees) to the plane occupied by curve of the hook 15 (see FIG. 10), the ports 21a, 21b of the surface 19 are aligned with the trough 29 perpendicular to the eye 17 and parallel to the plane occupied by curve of the hook 15 nearest the barb. This arrangement lends itself to the side-to-side oscillatory motion of the rig 11.

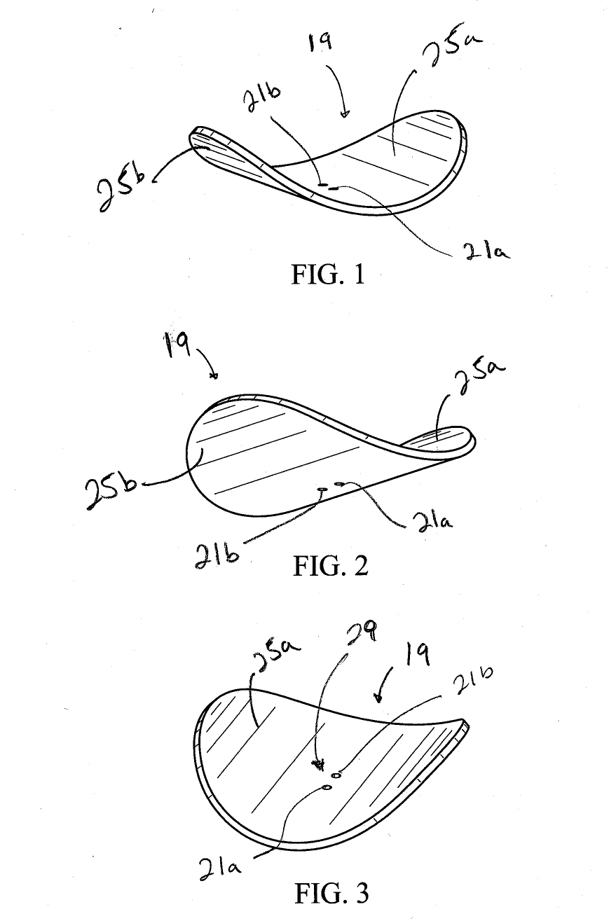

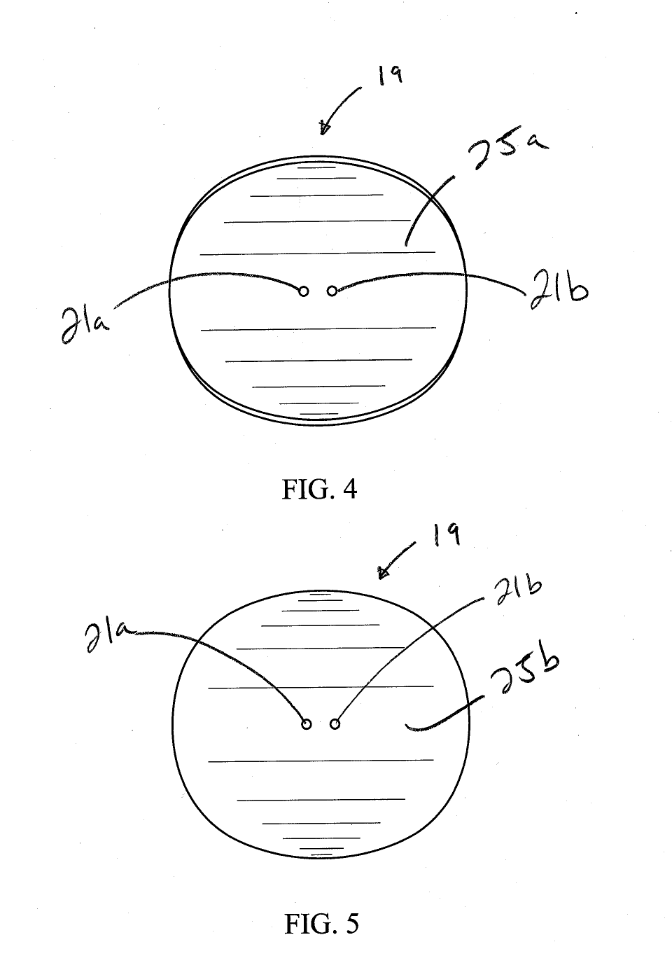

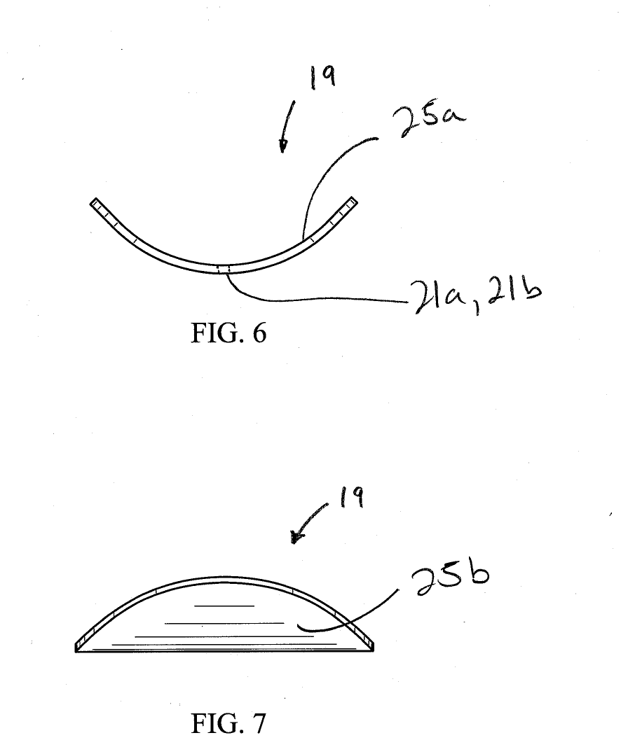

Referring to FIGS. 1-7, in the illustrated embodiment of the present invention, the quadratic surface 19 of the rig 11 may be described as a hyperbolic parabaloid on a circular domain describable by the function z=Ax²+By² where the B coefficient is at or near 0. By circular domain, the quadratic surface 19 is formed from a circular disc 105. In another embodiment of the present invention, the quadratic surface 19 is a saddle shaped disc. In another embodiment of the present invention, the quadratic surface 19 is a C shaped disc. In another embodiment of the present invention, the quadratic surface 19 is a round disc having a curved cross section at one axis and a straight cross section at a second axis. In another embodiment of the present invention, the quadratic surface 19 forms a trough 29 and the first and second ports (21a, 21b) are oriented such that each of the first and second ports form (21a, 21b) a line that is parallel to the trough 29. In another embodiment of the present invention, the quadratic surface 19 has a concave side 25a and convex side 25b. The convex side 25b faces or is nearest to the eye 17, and the concave side 25a is not facing or furthest to the eye 17 relative to the convex side 25b.

The quadratic surface 19, preferably is clear acetate film having a thickness of 0.020 inches. Preferably, the disc 105 or circular domain may range in size from ½ inch diameter, to 1¼ inch diameter in ⅛ inch increments. Although, there is no set limit.

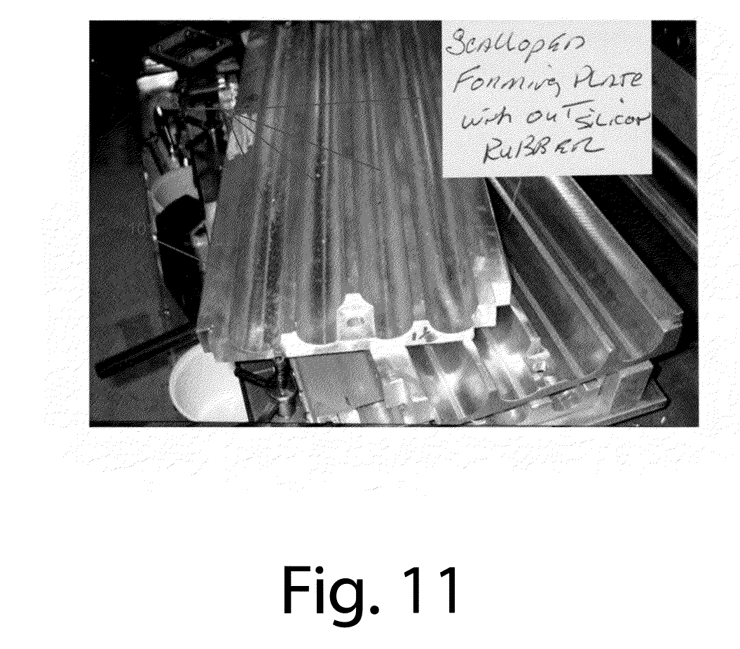

Referring to FIGS. 11-14 for illustration, the quadratic surface 19 is formed by heating and pressing discs 105, located on a forming mat 109, into semi-cylindrical shaped troughs 103 with forming bars 107. In a preferred embodiment the manufacture of the quadratic surface(s) 19 is accomplished with a press. The FIGS. 11-14 show only parts of the press for clarification.

FIG. 11 shows a forming plate 101 located outside of the press for clarification. The forming plate 101 has a semi-cylindrical shaped troughs 103. The dimensioning (that is the diameter or radius) of the of the semi-cylindrical shaped troughs 103 is dependent on the desired size of the quadratic surface 19. For example, for a disc of 1 inch diameter, the diameter of the semi-cylindrical shaped trough 103 is approximately 1 inch, and the depth of the of the semi-cylindrical shaped trough 103 is approximately half the diameter. Although, the invention is not limited to a particular dimension.

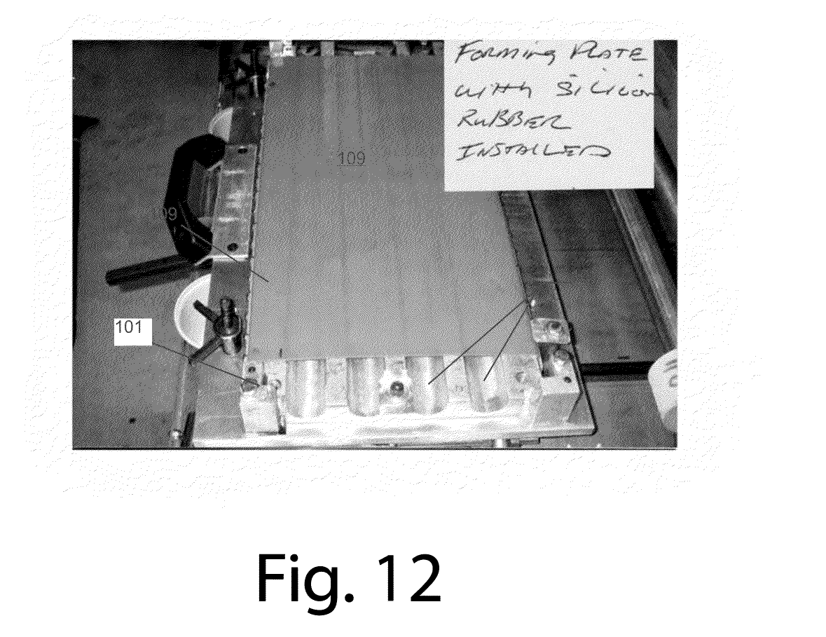

FIG. 12 shows a forming mat 109 laid over the trough(s) 103 of the forming plate 103. In a preferred embodiment the forming mat 109 is flexible and less conductive of heat than metal. A rubberized silicone material is preferred.

One or more discs 105 of material are provided. As discussed herein, the material, preferably is clear acetate film having a thickness of 0.020 inches. Preferably, the disc 105 or circular domain may range in size from ½ inch diameter, to 1¼ inch diameter in ⅛ inch increments. Although there is no set limit.

Moreover, the size of the disc 105 relative to the fly or lure of the rig will affect oscillation dynamics. When pulled through the water, the rig 11 will make an S-shaped or snake-like track from side to side—analogous to a sine wave. A smaller disc 105 or surface 19 will result in a tight oscillation (smaller amplitude or deviation from straight ahead). A larger disc 105 or surface 19 will result in a large oscillation (larger or more dramatic amplitude or deviation from straight line ahead).

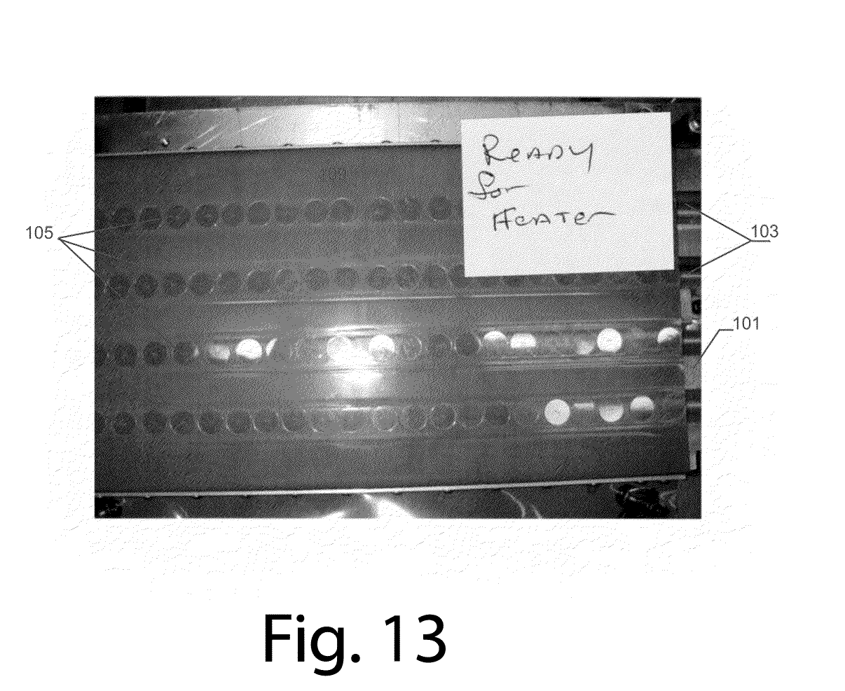

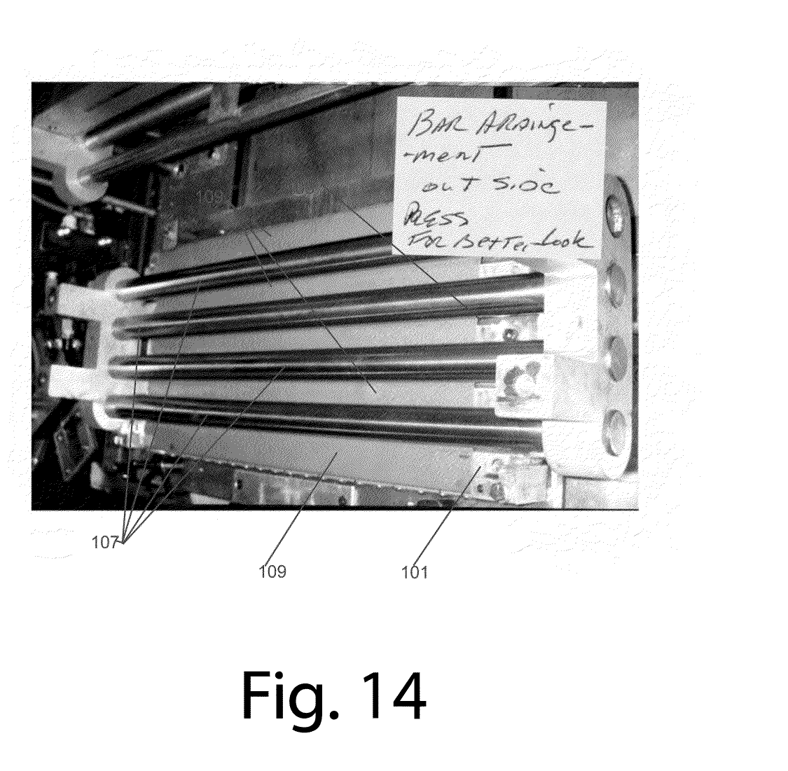

The discs 105 are then placed on the mat and aligned over the semi-cylindrical shaped trough 103. In a preferred embodiment, the first and second ports 21a, 21b form an imaginary line between them. The discs 105 are arranged such that the he imaginary line runs parallel with the length of the trough. FIG. 13 shows the discs 105 arranged on the forming mat 109, which is located over the semi-cylindrical shaped trough(s) 103 of the forming plate 101.

Once on the forming mat, the discs 105 are heated. In the preferred embodiment, heat is provided by infrared lighting placed over the discs 105 placed on the mat 109, located on the forming plate 101. Heat is applied sufficient to make the discs 105 malleable, but not destructive of the discs. Other heating methods may be employed sufficient to make the disks malleable, but destructive of the disks. It is also possible that in other methods of manufacture, the heating step may occur at a different time.

The forming bar(s) 107 are pressed onto the heated discs 105 on the forming mat 109. This causes the heated discs 105 and the forming mat 109 to press into the trough 103 of the forming plate 101. The forming bar is held in the trough 103 for 10 seconds, or a time sufficient for the discs to take the shape of the trough 103. The forming bar(s) 107 are sufficiently sized to fit within the semi-cylindrical shaped troughs(s) 103 of the forming plate 101, when pressing the forming mat 109 and disc(s) 105. FIG. 14 shows the forming bars 107 pressing the discs 105 and the forming mat 109 into the forming plate 101.

In a preferred embodiment, the first port 21a and the second port 21b are drilled into the discs 105 before the forming steps above are performed with the forming plate 101, forming mat 109, heating, and forming bar. The spacing for the ports 21a and 21b may vary depending on freshwater use and saltwater use. In freshwater, 1/16 inch center-to-center spacing is preferred for maximum oscillation dynamics. In saltwater, 3/32 inch center-to-center spacing is preferred for maximum oscillation dynamics.

The invention further includes a method of rigging a fly or lure 13 for use in fishing. The method includes a plurality of steps described herein and hereafter. A fly or a lure 13 is provided. The fly or lure 13 has a hook 15 forming part of, or embedded within the fly or lure 13. The hook 15 has an eye 17. A quadratic surface 19 is provided. The surface 19 having first and second ports (21a, 21b) disposed centrally on the quadratic surface 19 and extending through the surface 19. A length of leader is provided, which extends from a first end 23a. The first end 23a of the leader 23 is passed through the quadratic surface 19 at the first port 21a, then through the eye 17 of the hook 15, then through the second port 21b. The first end 23a of the leader 23 is then connected with the leader 23 at a second location or end 23b to form a loop 27. Preferably, the connection is with a non-slip knot to maintain the loop connection, rather than the surface 19 fixed to the eye 17 of the hook 15. Preferably, the loop 27 provides approximately 1 inch of play upon which the quadratic surface 19 may slide.

During use, as the fishing rig 11 is pulled through water, the force of the water passing over the quadratic surface 19 causes the quadratic surface 19 to slide along the loop 27 to abut the eye of the hook 15 of the fly or lure 13. The force of the water passing over the quadratic surface 19 causes the surface 19 to rock from side to side and the fly or lure 13 to oscillate between a first direction and a second direction to facilitate attracting fish to the fishing rig 11.

Although particular embodiments of the invention have been described in detail herein with reference to the accompanying drawings, it is to be understood that the invention is not limited to those particular embodiments, and that various changes and modifications, including the omission of steps or the interchangeability of the order of steps, may be effected therein by one skilled in the art without departing from the scope or spirit of the invention.

What is claimed:

1. A fishing rig for use in fishing, the fishing rig comprising:
a fly or a lure having a hook forming part of, or embedded within, the fly or lure, the hook having an eye,
a quadratic surface having first and second ports disposed centrally on the quadratic surface and extending through the surface, and
a leader of filament passing first through the first port of the quadratic surface, through the eye of the fly or lure, then through the second port forming a loop upon which the quadratic surface is free to slide to and away from the eye.

2. The fishing rig of claim 1, the quadratic surface is a hyperbolic paraboloid on a circular domain describable by the function z=Ax²+By² where the B coefficient is at or near 0.

3. The fishing rig of claim 1, the quadratic surface is a saddle shaped disc.

4. The fishing rig of claim 1, the quadratic surface formed by performing the following steps:
providing a forming plate having a semi-cylindrical shaped trough,
placing a disc of material over the semi-cylindrical shaped trough,
providing a cylindrical or semi-cylindrical shaped forming bar, heating the disc, and
pressing the disc into the semi-cylindrical shaped trough with the forming bar.

5. The fishing rig of claim 1, the quadratic surface is a C shaped disc.

6. The fishing rig of claim 1, the quadratic surface is a round disc having a curved cross section.

7. The fishing rig of claim 1, the quadratic surface forms a trough and the first and second ports oriented such that each of the first and second ports form a line that is parallel to the trough.

8. The fishing rig of claim 1, the quadratic surface having a concave side and convex side, the convex side facing or nearest to the eye, and the concave side not facing or furthest to the eye relative to the convex side.

9. A method of rigging a fly or lure for use in fishing comprising the steps of:
providing a fly or a lure having a hook forming part of, or embedded within the fly or lure, the hook having an eye,
providing a quadratic surface on a circular domain having first and second ports disposed centrally on the quadratic surface and extending through the surface,
provide length of a leader extending from a first end to a second end,
passing the first end of the leader through the quadratic surface at the first port, then through the eye of the hook, then through the second port,
connecting the first end of the leader with the second end of the leader.
